(19) United States
(12) Patent Application Publication
(10) Pub. No.: US 2025/0187874 A1
(43) Pub. Date: Jun. 12, 2025

(54) SAFETY DEVICE FOR AN ELEVATOR

(71) Applicant: CEDES AG, Landquart (CH)

(72) Inventor: Bernd KAGERER, Duesseldorf (DE)

(73) Assignee: CEDES AG, Landquart (CH)

(21) Appl. No.: 18/967,793

(22) Filed: Dec. 4, 2024

(30) Foreign Application Priority Data
Dec. 11, 2023 (EP) 23 215 576.2

(51) Int. Cl. B66B 5/00; B66B 1/34

(52) U.S. Cl. CPC B66B 5/0031; B66B 1/3461

(57) ABSTRACT

A security device for an elevator comprising an elevator car comprising a car door, comprising an accelerometer for detecting the vibration of the car door, comprising a pre-evaluation apparatus for determining shaking of the car door on the basis of the comparison of the detected vibration with at least one threshold value, comprising a transmission apparatus for transmitting vibration signals on the basis of the detected vibration to a server, and comprising a server for analyzing the vibration signals, wherein the pre-evaluation apparatus is physically connected to the elevator car, the transmission apparatus then transmits the vibration signals if the pre-evaluation apparatus determines shaking and the server is physically separate from the elevator and weights the transmitted vibration signals and stores and/or outputs the information for the probable cause of the shaking depending on the weighting.

This application claims the benefit under 35 USC § 119 (a)-(d) of European Application No. 23 215 576.2 filed Dec. 11, 2023, the entirety of which is incorporated herein by reference.

### FIELD OF THE INVENTION

The present invention relates to a security device for an elevator in order to detect vandalism directed toward the elevator door.

### BACKGROUND OF THE INVENTION

Security devices of the type mentioned, which monitor the elevator car using a camera, are known from the prior art. This may entail legal problems.

### SUMMARY OF THE INVENTION

The object of the present invention is to provide an improved security device of the type mentioned.

The security device according to the present invention is a security device for an elevator comprising an elevator car comprising a car door, comprising an accelerometer for detecting the vibration of the car door, comprising a pre-evaluation apparatus for determining shaking of the car door on the basis of the comparison of the detected vibration with at least one threshold value, comprising a transmission apparatus for transmitting vibration signals on the basis of the detected vibration to a server, and comprising a server for analyzing the vibration signals, wherein the pre-evaluation apparatus is physically connected to the elevator car, the transmission apparatus then transmits the vibration signals if the pre-evaluation apparatus determines shaking and the server is physically separate from the elevator and weights the transmitted vibration signals and stores and/or outputs the information for the probable cause of the shaking depending on the weighting.

The security device can afford the advantage that the amount of data to be transmitted to the server is able to be kept low. The security device can afford the advantage that legal problems in relation to data protection are avoided. The security device can afford the advantage that the parts of the security device on the car can manage with relatively little computing capacity, as a result of which they can become more cost-effective.

The elevator may be a passenger elevator.

The accelerometer may be attached to the car door.

Shaking is a particular characteristic of the vibration detected by the accelerometer and may correspond, for example, to a knock or bump against the elevator door.

The accelerometer preferably detects the vibration during the opening and/or closing process, and/or in the open or closed state, of the car door.

The pre-evaluation apparatus preferably determines the shaking by virtue of the amplitude of the vibration exceeding a threshold value.

The pre-evaluation apparatus preferably determines the shaking by virtue of the amplitude of the vibration periodically exceeding a threshold value.

The pre-evaluation apparatus preferably determines the shaking by virtue of a specific frequency, in particular, the natural frequency of the door, being detected.

The pre-evaluation apparatus preferably determines the shaking by virtue of a frequency analysis and/or a wavelet analysis being performed.

The pre-evaluation apparatus preferably determines the shaking by virtue of a frequency analysis with a pattern recognition being performed.

The server preferably weights the vibration signals by virtue of the amplitude of the vibration exceeding a threshold value.

The server preferably weights the vibration signals by virtue of the amplitude of the vibration periodically exceeding a threshold value.

The server preferably weights the vibration signals by virtue of a specific frequency, in particular, the natural frequency of the door, being detected.

The server preferably weights the vibration signals by virtue of a frequency analysis and/or a wavelet analysis being performed.

The server preferably weights the vibration signals by virtue of a frequency analysis with a pattern recognition being performed.

Further features of the present invention are indicated in the drawings.

The advantages mentioned in each case may also be achieved for combinations of features in connection with which they are not mentioned.

### BRIEF DESCRIPTION OF THE DRAWINGS

Exemplary embodiments of the present invention are illustrated in the drawings and are explained in more detail below. The same reference signs in the individual figures in this case denote elements that correspond to one another.

FIG. 1 shows a flowchart for the security apparatus.

### DETAILED DESCRIPTION OF THE INVENTION

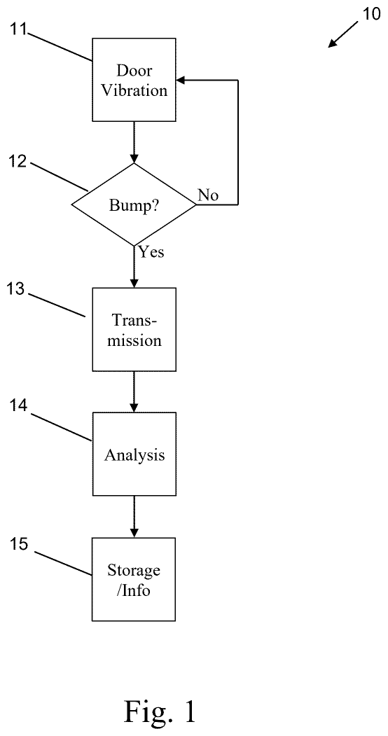

FIG. 1 shows a flowchart for the security apparatus 10. The sequence starts with the accelerometer 11.

The accelerometer 11 measures the vibration of the car door in the closed state. The accelerometer forwards the measured values for the vibration to the pre-evaluation apparatus 12.

The pre-evaluation apparatus 12 analyzes the received measured values by comparing the amplitude of the measured values with at least one threshold value. If the at least one threshold value is not exceeded, the sequence begins again with the accelerometer 11. If the at least one threshold value is exceeded, the sequence continues to the transmission apparatus 13.

The transmission apparatus 13 transmits the measured values of the vibration sensor to a server 14 wirelessly by means of an Internet protocol.

The server 14 analyzes and weights the received measured values, assigns the information to the measured values, depending on the weighting, as to whether or not there is vandalism, and stores this information for output to a service center.

### LIST OF REFERENCE SIGNS

10 Flowchart for the security apparatus
11 Accelerometer
12 Pre-evaluation apparatus
13 Transmission apparatus
14 Server
15 Output apparatus

1-12. (canceled)

13. Security device for an elevator comprising an elevator car comprising a car door, comprising:
an accelerometer for detecting the vibration of the car door,
a pre-evaluation apparatus for determining shaking of the car door on the basis of the comparison of the detected vibration with at least one threshold value,
a transmission apparatus for transmitting vibration signals on the basis of the detected vibration to a server, and
a server for analyzing the vibration signals,
wherein the pre-evaluation apparatus is physically connected to the elevator car, the transmission apparatus then transmits the vibration signals if the pre-evaluation apparatus determines shaking and the server is physically separate from the elevator and weights the transmitted vibration signals and stores and/or outputs the information for the probable cause of the shaking depending on the weighting.

14. A security device according to claim 13, wherein the accelerometer detects the vibration during the opening and/or closing process, and/or in the open or closed state, of the car door.

15. A security device according to claim 13, wherein the pre-evaluation apparatus determines the shaking by virtue of the amplitude of the vibration exceeding a threshold value.

16. A security device according to claim 13, wherein the pre-evaluation apparatus determines the shaking by virtue of the amplitude of the vibration periodically exceeding a threshold value.

17. A security device according to claim 13, wherein the pre-evaluation apparatus determines the shaking by virtue of a specific frequency, in particular the natural frequency of the door, being detected.

18. A security device according to claim 13, wherein the pre-evaluation apparatus determines the shaking by virtue of a frequency analysis and/or a wavelet analysis being performed.

19. A security device according to claim 13, wherein the pre-evaluation apparatus determines the shaking by virtue of a frequency analysis with a pattern recognition being performed.

20. A security device according to claim 13, wherein the server weights the vibration signals by virtue of the amplitude of the vibration exceeding a threshold value.

21. A security device according to claim 13, wherein the server weights the vibration signals by virtue of the amplitude of the vibration periodically exceeding a threshold value.

22. A security device according to claim 13, wherein the server weights the vibration signals by virtue of a specific frequency, in particular the natural frequency of the door, being detected.

23. A security device according to claim 13, wherein the server weights the vibration signals by virtue of a frequency analysis and/or a wavelet analysis being performed.

24. A security device according to claim 13, wherein the server weights the vibration signals by virtue of a frequency analysis with a pattern recognition being performed.
